(19) United States
(12) Patent Application Publication
(10) Pub. No.: US 2024/0379128 A1
(43) Pub. Date: Nov. 14, 2024

(54) CATEGORY-BASED MEDIA EDITING

(71) Applicant: CenturyLink Intellectual Property LLC, Denver, CO (US)

(72) Inventors: John R.B. Woodworth, Amissville, VA (US); Dean Ballew, Sterling, VA (US)

(73) Assignee: CenturyLink Intellectual Property LLC, Denver, CO (US)

(21) Appl. No.: 18/652,110

(22) Filed: May 1, 2024

Related U.S. Application Data
(60) Provisional application No. 63/501,843, filed on May 12, 2023.

(51) Int. Cl. G11B 27/031

(52) U.S. Cl. CPC G11B 27/031

(57) ABSTRACT

Systems and methods for providing category-based media editing. A media editing service may include an artificial-intelligence/machine-learning editor trained to recognize patterns and characteristics of various attributes of various categories. A user of a streaming service may select a media item and further select a category that may be related to a current content. The streaming service may user the editor to detect occurrences of attributes of the selected category in the media item and to generate editing instructions to obfuscate, hide, remove, skip, or replace detected content with other content based on various filter settings. For instance, the editing instructions may be used to edit the media item such that undesired content including attributes of the selected category may be filtered.

### CROSS-REFERENCE TO RELATED APPLICATIONS

This application claims the benefit of U.S. Provisional Application No. 63/501,843 filed May 12, 2023, entitled “Category-Based Media Editing,” which is incorporated herein by reference in its entirety.

### BACKGROUND

Media items can include content that may not be appropriate for all situations or audiences. For instance, a viewer may consider certain audio and/or visual content as inappropriate for consumption in a dinner setting and/or may consider other content as inappropriate before bedtime. It is with these observations in mind, among others, that aspects of the present disclosure were conceived.

### SUMMARY

The present disclosure describes a system and method for providing category-based media editing. One aspect of the present disclosure includes a method, comprising: receiving a media item; receiving a category associated with one or more attributes; detecting target content in the selected media item, wherein the target content includes one or more of the attributes associated with the selected category; generating editing instructions to filter the target content from the media item; and providing the editing instructions, wherein executing the editing instructions causes the media item to be edited such that, when played, an edited version of the media item is played with the target content filtered from the media item.

Another aspect of the present disclosure includes a method, comprising: receiving selection of a media item from a plurality of editable media items; providing a plurality of filter categories, where each filter category is associated with one or more attributes; receiving a selection of a first filter category of the plurality of filter categories; sending the selected media item and the one or more attributes associated with the first filter category to a machine-learning trained editor to detect target content related to the first filter category in the selected media item; receiving, from the editor, information about one or more occurrences of detected target content related to the first filter category and editing instructions to filter the one or more occurrences of target content from the media item; and executing the editing instructions to edit the media item such that, when an edited version of the media item is played, one or more occurrences of detected target content related to the first filter category is filtered from the media item.

Another aspect of the present disclosure includes a system, comprising: at least one processor; and memory storing instructions that, when executed by the at least one processor, cause the system to: receive a selection of a media item from a plurality of editable media items; receive a selection of a first filter category of a plurality of filter categories; use a machine-learning trained editor to: detect target content related to one or more attributes associated with the first filter category in the selected media item; and generate a first set of editing instructions to filter the detected target content from the media item; and one of: provide the first set of editing instructions to a player of the media item; or use the first set of editing instructions to edit the media item; and provide the edited media item to the player.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures.

FIG. 1 is a block diagram showing an example system in which a system may be implemented for providing category-based media editing according to an example.

FIG. 2 is a block diagram showing an example data flow for providing category-based media editing according to an example.

FIG. 3 is a flowchart illustrating operations of a method for providing category-based media editing according to an example.

FIG. 4 is a flowchart illustrating operations of a method for providing category-based media editing according to an example.

FIG. 5 is a block diagram of a computing device with which one or more aspects of the disclosure may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Examples of the present disclosure describe systems and methods for providing category-based media editing. In some examples, media item editing may be provided as a service, allowing users of a streaming service to select one or more categories related to a current context, setting, or other factor, and be provided with an edited version of a requested media item. For instance, the edited version of the media item may filter out content that may be classified as related to the category. For example, filtered content may include content that may be classified as inappropriate or otherwise unsuitable to consume in the context related to the selected category(s). According to examples, an artificial intelligence/machine learning model may be trained and used to detect target content in a media item and to generate editing instructions for filtering and/or editing the target content.

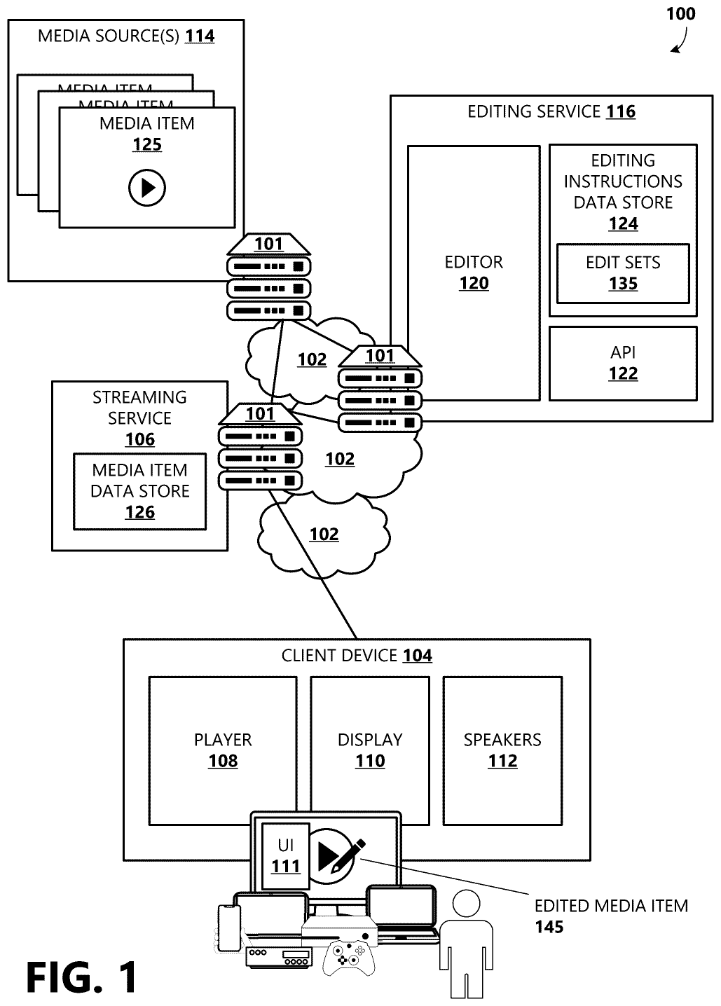

With reference now to FIG. 1, an example network system 100 is described in which category-based media editing may be implemented. In an example implementation, the system 100 includes a client device 104 communicatively connected to a streaming service 106 via one or a combination of networks 102. The client device 104 may be one of various types of devices that receives media items 125 (sometimes also referred to herein as media content or media content items) from the streaming service 106 and plays the media items 125 via a player 108. For instance, the client device 104 may include a computing or streaming device, such as a smartphone, a personal computer, a tablet, a gaming console, a smart television, a set-top box, etc. Media items 125 may include audio and video streams of live and/or on-demand video (e.g., movies, shows, television programs, sporting events), game content, and/or other types of playable content. According to examples, the player 108 plays streams of media items 125. The player 108 may be a dedicated application, an internet browser, an operating system module, or other system operative to consume at least a subset of a total media content item 125 and play the included audio and video for presentation to a user in real-time, live, or on-demand. In further examples, the player 108 may further download a store a media content item 125 locally on the client device 104. According to examples, the client device 104 may include or be operatively connected to a display 110 and one or more speakers 112 via which media items 125 may be displayed and played, respectively.

The streaming service 106 may operate on one or a plurality of servers 101. In some examples, the streaming service 106 may be associated with a media provider that provides media items 125 for display/play to users. In some examples, the media provider provides subscriptions to the streaming service 106, where subscribers may be charged a monthly fee to receive access to media items 125. In other examples, media items 125 may be accessed from the streaming service 106 on a pay-per-view basis. In other examples, the media items 125 may be purchased. In further examples, media items 125 may be accessed from the streaming service 106 for free and may include advertisements that are played with the media items 125. The media items 125 may be provided to the streaming service 106 by one or a plurality of media sources 114. For instance, a media source 114 may own or hold rights to a media item 125, which may include distributing and/or profiting from distribution of the media items 125. In some examples, the media source(s) 114 are separate from the streaming service 106. In other examples, the streaming service 106 and one or more media sources 114 may be operated by a same entity on a same server 101 or group of servers 101. According to examples, the streaming service 106 may store one or various copies of media items 125 in their original formats in one or more media item data stores 126.

In some examples, the streaming service 106 offers media item editing as a service to customers (e.g., a service which customers can subscribe to access and use). For instance, the streaming service 106 may include or may be in communication with an editing service 116. According to examples, the editing service 116 includes an editor 120 that detects target content in a media item and generates editing instructions that filter the target content from the media item 125. Examples of edits to target content in a media item 125 include obfuscating the content, skipping the content, replacing the content with other content, hiding or removing the content, etc. For instance, the target content may include an object, person, animal, displayed text, or other visual elements in a video frame or sequence of frames. In other examples, the target content may include a word, a phrase, a sound, or other audible elements.

In some examples, target content includes one or more detectable attributes corresponding to a user-selected category. Some categories may correspond to a particular context, such as a “dinner” category corresponding to a dinner setting/context. For instance, in a dinner setting, certain content may have attributes that may be deemed as inappropriate or otherwise unsuitable to view or listen to while eating a meal (e.g., gory content, gross content). Other non-limiting examples of attributes that may be associated with a category include various types of violence, drug/substance use, profane language, nudity, sexual content, certain words/language, a noise level, certain types of activities, objects associated with certain phobias or other sensitivities, user-defined attributes, etc. User-defined attributes, for instance, may include a particular actor, actress, performer, object, type of animal, type of activity, etc. Features of attributes may include image pixels, image frames, audio waveforms, or other data that can be used to distinguish between attributes. In some examples, a feature of an attribute includes a number of times or an amount of time the attribute may occur in a media item 125.

In some examples, the player 108 may provide a user interface (UI) 111 for presenting media items 125, that may be selected to play or download, and filter categories that may be selectively applied to media items 125. In some examples, the UI 111 may further include options for selecting or adjusting various filter settings. As an example, a user may select to play a media item 125 while eating a meal and may further select a “dinner” category to filter target content from the media item 125, where target content includes content that may be classified as inappropriate or otherwise unsuitable to view or listen to in a context related to the selected category (e.g., while eating a meal for the “dinner” category). As another example, a user may select a “bedtime” category when about to go to bed to filter content from a media item 125 that is violent, scary, loud, etc. In some examples, a plurality of categories and their attributes are predefined. In further examples, categories and attributes may be configurable. A variety of predefined categories having attributes related to a variety of contexts are contemplated and are within the scope of the present disclosure.

In some examples, an option may be included in the UI 111 to allow a user to allow and/or disallow attributes for a category. For instance, various predefined attributes may be presented in the UI 111 from which the user may select. In some implementations, the UI 111 may include an option for allowing the user to input an attribute. For instance, a user may input a keyword corresponding to a target content to be detected and filtered from a selected media item 125. As an example, the user may sometimes experience nightmares when consuming content abouts certain types of activities too close to bedtime (e.g., activities that involve heights), but, at bedtime, may want to watch a movie (media item 125) that includes some rock-climbing scenes that the user wants to avoid. Thus, the user may select the “bedtime” category and may further select or add a “rock climbing” or “heights” attribute to the “bedtime” category to cause rock climbing scenes or other scenes involving heights to be filtered. Thus, the user may use the UI 111 to indicate a preference to customize which attributes of a selected category are excluded/edited from a selected media item 125.

In further examples, an option may be included in the UI 111 that may allow the user to create a new category and to further input or select attributes to associate with the new category. As an example, the user may create a “my filter” category and select and/or input a plurality of attributes corresponding to the user's preferences, sensitivities, principles, etc. As an example, the user may have a phobia to spiders and may not want to view or hear about spiders while consuming a media item 125. Upon selecting to play a media item 125 (e.g., a movie), the user may further select to view an edited version of the movie by selecting a predefined “arachnophobia” category, or by creating an “arachnophobia” category and selecting or inputting “spiders” as an attribute of the category. For instance, the user may select the “arachnophobia” category in association with selection to play the media item 125, so that visual representations of spiders, spoken utterances of the word “spider”, etc., may be obfuscated, removed, or skipped.

In other examples, an option may be included in the UI 111 to allow a user to indicate a preference to include an attribute rather than a preference to exclude/edit content associated with the attribute from a media item 125 to avoid the attribute. For instance, the user may user the UI 111 to select a particular actor and select a preference to only see scenes in a media item 125 that include that actor.

In additional examples, some options included in the UI 111 may allow the user to adjust a filtering level of categories and/or attributes within a range of levels. In some implementations, the filter levels may be associated with an amount (e.g., a number of occurrences of an attribute) or intensity of desired filtering. In further implementations, the filtering levels are associated with patterns and characteristics of different classes of an attribute. For instance, a “violence” attribute may include different types or classes of violence that distinguish one type/class of violent content from another, such as a level of realism (e.g., simulated violence, realistic violence, or cartoon violence), the use of weapons, the presence of blood or gore, physical altercations, violent dialogue, etc. In some examples, the user may select a filtering level for a category, which may allow or disallow one or more attributes in the category and/or one or more attribute classes in one or more of the attributes. For instance, some classes of an attribute may be classified as more acceptable for a context/category, while other classes of the attribute may be classified as less acceptable for the context/category. For instance, a lower filter level in association with an attribute may correspond to allowing some occurrences of the attribute or more-acceptable classes of the attribute to be unfiltered, while a higher filter level may correspond to filtering all detected occurrences of the attribute or filtering all less-acceptable classes of the attribute from a media item 125.

In further examples, an option may be included in the UI 111 that may allow the user to adjust an editing level corresponding to a degree/level of editing applied to detected target content. For instance, a lower editing level may correspond to a lower level of obfuscation and a higher editing level may correspond to a higher level of obfuscation or skipping of detected target content. For instance, a lower level of obfuscation may include blurring detected visual content and/or silencing or bleeping detected audio content. The higher editing level may include blocking out or skipping frames of the media item 125 that include detected visual content. In still further examples, an option may be included in the UI 111 that may allow the user to replace detected target content with different content (e.g., an image, an audio clip, a video clip). Other types of media item filter settings and options are possible and are within the scope of the present disclosure.

According to examples, the streaming service 106 is in communication with the player 108 and receives the user selections (e.g., media item, category, attribute, filtering level, editing level). In some examples, the streaming service 106 obtains the media item 125 selected by the user from the media item data store 126 and provides the media item 125 and media item, category, attribute, filtering level, and editing level selections to the editing service 116. For instance, the editing service 116 may use the editor 120 to detect target content in the media item 125 based on the user selections. In some implementations, the editor 120 may be modeled as a machine learning (ML) system by incorporating artificial intelligence (AI) and deep learning techniques. For instance, the editor 120 may be trained on a training dataset including large amounts of video and audio data, as well as information on content related to attributes of various categories and editing techniques and styles to obtain a desired outcome (e.g., an edited media item 145). In some examples, the editor 120 may be trained using a labeled dataset including examples of features of content in association with an attribute or an attribute class and examples that are not. For instance, the editor 120 may be trained to detect features of attributes and/or attribute classes corresponding to a selected category using supervised ML techniques.

As an example, the editor 120 may be trained to recognize patterns and characteristics of violent content, where “violence” may be an attribute of one or more filter categories (e.g., a “Bedtime” category, a “Morning Coffee” category). As an example, ML algorithms may be used to train the editor 120 to recognize scenes and dialogue that include visual cues of violence (e.g., a presence of weapons, aggressive actions, blood, gore, physical altercations). In a further example, the editor 120 may use natural language processing (NLP) to analyze the dialogue of media items 125 (e.g., in an accompanying transcript, subtitles, and/or captions) to identify scenes or dialogue that include violence, such as violent language or threatening statements. For instance, the editor 120 may learn to distinguish between attributes corresponding to a category (e.g., spiders correspond to an “Arachnophobia” category) and between features of content corresponding to an attribute (e.g., visual features/aspects of a spider, spoken language about a spider).

In additional examples, the editor 120 may be further trained to recognize patterns and characteristics of different attribute classes. As an example, the editor 120 may be trained to recognize different types/classes of violent content (e.g., simulated violence, realistic violence, cartoon violence, and/or other types of violence) and then generate edit instructions to filter/edit accordingly. For instance, the editor 120 may be trained using a dataset of examples of different types of violent content, labeled with information about the type of violence depicted. The system may then learn to recognize the patterns and characteristics that distinguish one type of violent content from another, such as a level of realism, the use of weapons, or the presence of blood or gore, and then be further trained or instructed to filter each type of violent content differently.

In some examples, the editing service 116 may expose an editing service application programming interface (API) 122 or a UI to a media source 114 via which one or more categories, attributes, and/or attribute classes associated with the target content are presented to the media source 114. For example, the media source 114 may use the API 122 or UI to provide information corresponding to target content included in a media item 125, such as time index information, frame position information (e.g., position of a target object in a video frame). For instance, the editor 120 may be trained on such information received from the media source 114. In further examples, the editor 120 may be trained on user-selection information, such as user selections of one or more attributes in relation to a category, user feedback, and/or other training data.

In some examples, the editor 120 may store information about detected target content in one or more edit sets 135. According to examples, the editor 120 may record information, such as time index information, video frame identifiers, frame position information (e.g., position of pixels or a bounding box of pixels including a detected object in a video frame), etc. In some examples, each edit set 135 may include information about detected target content in association with one selected category or in association with a plurality of selected categories. In other examples, each edit set 135 may include information about detected target content in association with one attribute of a selected category.

In some implementations, the editor 120 may be further trained to generate editing instructions for filtering or editing detected target content. For instance, the editor 120 determines instructions for editing occurrences attributes of a selected category based on predefined or user-selected filtering and editing levels. According to examples, the editing instructions may cause a receiving system to obfuscate, hide, remove, skip, or replace target content with other content a media item 125. For instance, the editor 120 generates non-linear edits for the media item 125 and stores the non-linear edits as a separate file (e.g., in the one or more edit sets 135). As depicted in FIG. 1, edit sets 135 may be stored in an editing instructions data store 124.

According to examples, the streaming service 106 may access, receive, or otherwise obtain the edit set(s) 135, where the edit set(s) 135 include instructions generated by the editor 120 to filter/edit detected target content in the media item 125. In some implementations, the streaming service 106 uses the editing instructions to edit the media item 125 and then stream an edited version of the media item 125 (an edited media item 145) to the client device 104 for play via the player 108. In other implementations, the streaming service 106 sends the media item 125 and the edit set(s) 135 to the client device 104, where the player 108 uses the editing instructions to edit the media item 125 and play the edited media item 145 for display to the user. For instance, the user may be able to watch the edited media item 145 without consuming undesired content. For example, the undesired content may be obfuscated, hidden, removed, skipped, or replaced in the edited media item 145.

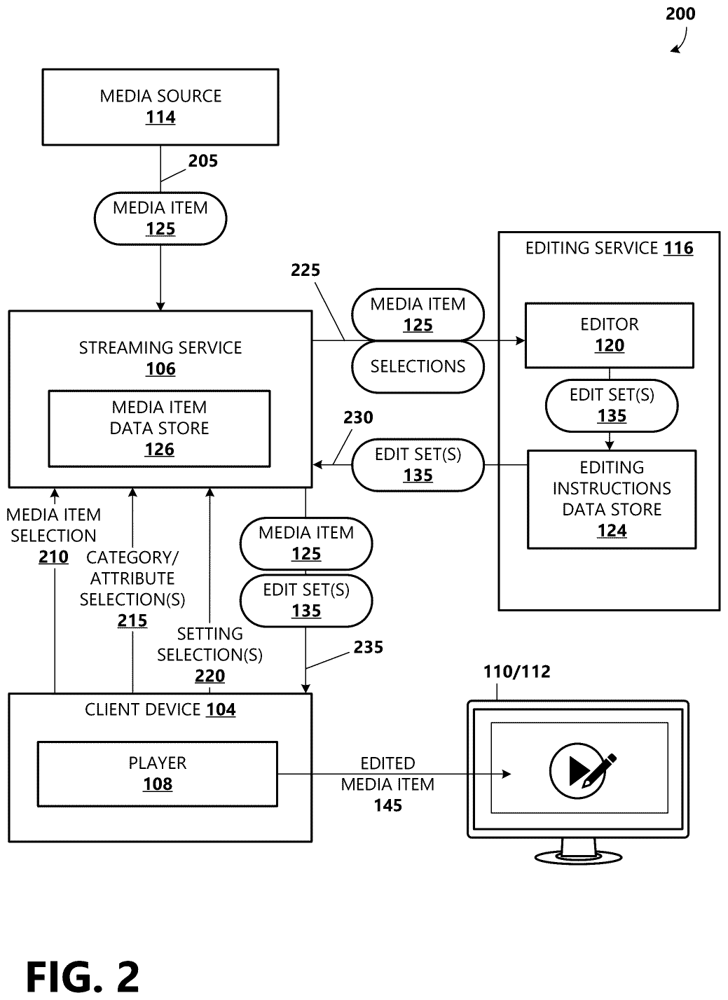

With reference now to FIG. 2, an example data flow 200 for providing category-based media editing is depicted. According to examples, one or more media sources 114 provide media items 125, such as audio and video streams of live and/or on-demand video content (e.g., movies, shows, television programs, sporting events), game content, audio content (e.g., music, podcasts), and/or other types of playable content, to one or more streaming services 106 to be streamed to customers. Data communication 205 represents a communication of a media item 125 to a streaming service 106. For instance, the media item 125 may be in its original (e.g., unedited) format. According to examples, the streaming service 106 may store one or various copies of the media item 125 in its original format in one or a plurality of media item data stores 126. In some implementations, the media source 114 may provide editing rights in association with the media item 125. In some examples, the editing rights allow the editing service 116 to edit the media item 125. In other examples, the editing rights allow the editing service 116 to perform certain edits and/or a limited amount of editing (e.g., a threshold number of edits, a threshold ratio of edited to non-edited content) to the media item 125.

According to examples, a user of a client device 104 may use a player 108 operating on the device to select the media item 125 to play or download onto the client device 104 for later playback. In some examples, a UI 111 is presented via which the user may make the selection of the media item 125. A communication of the selection of the media item 125 to the streaming service 106 is represented in FIG. 2 as data communication 210. In some examples, the user may further select one or more categories to apply as filters to the media item 125, which is represented as data communication 215. As an example, the user may want to watch the media item 125 while eating a meal and may select a “dinner” category in association with viewing the media item 125, where the “dinner” category may include various attributes that the editor 120 may be trained to detect. Continuing with the example, the user may also be in the company of an older relative or a child and may additionally select a “family-appropriate” or “general-audience appropriate” category. For instance, the “dinner” category may include a first set of attributes and the “general-audience appropriate” category may include a second set of attributes. In some examples, an attribute may be included in more than one selected category.

In some examples, the user may select one or various options presented in the UI 111 to allow or disallow particular attributes and/or attribute classes, to adjust filtering levels, and/or to adjust editing levels. Continuing further with the example above, the user may have a dislike for a particular actor or show character and may wish to skip scenes of the media item 125 that include the particular actor/character. In some examples, the user may select or input the actor/character as an attribute of a new category. In further examples, the user may add or remove one or more attributes to/from a predefined category. For instance, the user may select to allow or disallow an attribute in a selected category. As an example, the user may have a phobia or (rational or irrational) sensitivity to a particular object. For illustration, the user may have an aversion to seeing chewed gum or hearing gum being chewed (e.g., chiclephobia), where the user may be repulsed by but may be able to tolerate seeing/hearing chewing gum except while eating. Thus, the user may select to include “gum”, “chewed gum”, and/or “chewing gum” as an attribute of the “dinner” category. Other example category or attribute selections may be made.

In further examples, the user may select or modify one or more filter settings. For instance, the user may select different filtering and/or editing levels in association with a category, attribute, or attribute class. A selection and communication of one or more filter settings to the streaming service 106 is represented as data communication 220. In some examples, data communications 210, 215, and/or 220 may be combined.

According to some examples, the streaming service 106 may access the requested media item 125 from the media item data store 126 and provide the media item 125 to the editing service 116 along with received category and/or attribute selections and filter setting selections. A communication of the media item 125 and the selections are represented in FIG. 2 as data communication 225. In some examples, the editor 120 may use one or a combination of NLP, machine learning algorithms, and rules to detect and classify content as being related to attributes of the selected category(s) based on one or a range of filter settings. In some examples, the editor 120 records location/position information (e.g., time, frame, location in a frame) about detected target content. In some examples, the editor 120 further determines editing instructions for the detected occurrences of attributes in the media item 125. For instance, the editor 120 determines instructions for editing detected target content based on preset or user-defined editing level settings and stores the instructions in one or more edit sets 135. In some examples, the edit sets 135 may be stored in an editing instructions data store 124. The edit set(s) 135 are provided to or accessed by the streaming service 106, which is represented in FIG. 2 as data communication 230.

In some examples, the streaming service 106 uses the editing instructions in the edit set(s) 135 to edit the media item 125 and then stream an edited media item 145 to the client device 104 for play via the player 108. In other examples, and as depicted in FIG. 2 as data communication 235, the streaming service 106 may send the media item 125 and the edit set(s) 135 to the client device 104, where the player 108 may use the editing instructions to edit the media item 125 and play the edited media item 145.

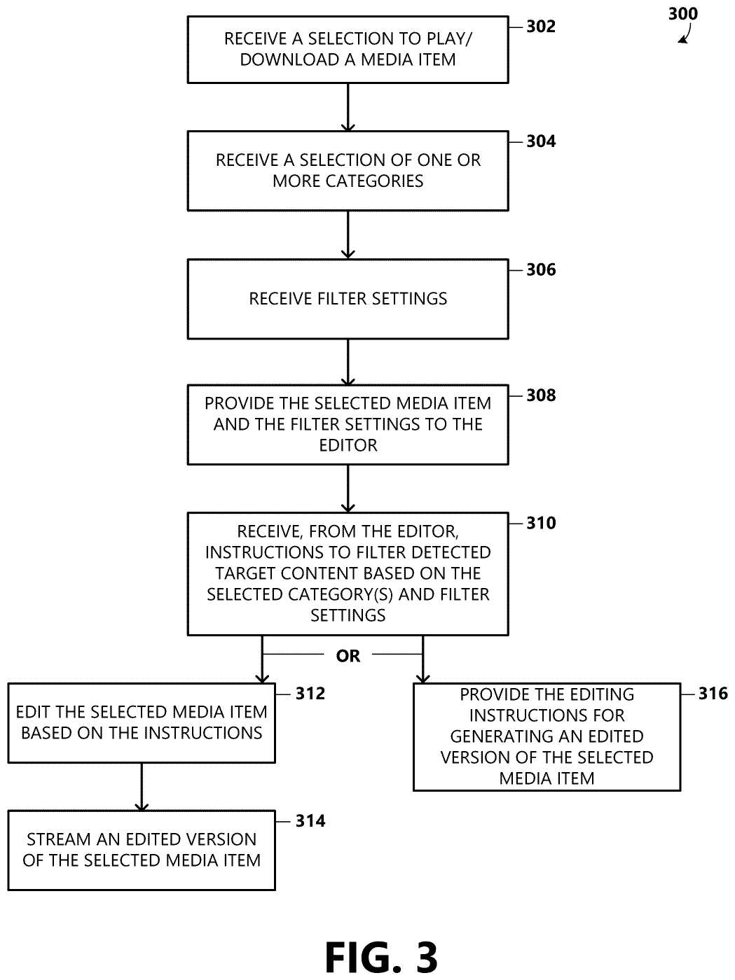

FIG. 3 is a flowchart that includes operations of a method 300 of providing category-based media editing according to an example. For example, one or more of the operations may be performed by components of a streaming service 106 that includes or is in communication with an AI/ML editor 120. At operation 302, a selection of a media item 125 may be received. For instance, the streaming service 106 may be in communication with a player 108 operating on a client device 104 and may present media items 125 in a UI 111. In some examples, the presented media items 125 include media items 125 for which editing rights may be allowed.

At operation 304, various filter categories may be presented to a user of the client device 104 via the UI 111 and a selection of one or more of the filter categories or a user input of a new category may be received. According to example, the selected category(s) may be associated with one or more attributes that the editor 120 is trained to detect.

At operation 306, various filter settings may be received. In some examples, the received filter settings may correspond to a predefined or user-selected filtering level of a category, attribute, or attribute class. In further examples, the received filter settings may include predefined or user-selected editing filter settings that may correspond to a degree/level of editing (e.g., obfuscation or skipping) to apply to detected target content.

At operation 308, the selected media item 125 and filter settings may be provided to the editor 120. For instance, a request may be made to detect and generate editing instructions for target content associated with the selected category(s) and filter settings. In response, one or more edit sets 135 including editing instructions may be generated by the editor 120. In some examples, two categories may be selected by the user for the media item 125, where the edit instructions include edits for both categories that affect a same section of the media item 125.

In some examples, the edit instructions include a priority ranking that causes edits for one category or attribute to take precedence over the edits of the other category or another attribute. For instance, if editing filter settings indicate a higher level of editing for a nudity attribute (e.g., skipping the scene) and a lower level of editing for a violence attribute (e.g., obfuscating the object/action) and a scene includes both nudity and violence, the edit instructions may include a priority ranking that causes the edits corresponding to the nudity attribute to be prioritized and, thus, for the scene to be skipped. At operation 310, the editing instructions may be received by the streaming service 106.

In some examples, the method 300 may proceed to operation 312, where the selected media item 125 may be edited based on the received editing instructions and an edited version of the media item (e.g., edited media item 145) may be streamed to the client device 104 at operation 314 to be played by the player 108. In other example, the method 300 may proceed from operation 310 to operation 316, where the one or more editing sets 135 may be passed to the client device 104, where the player 108 may generate the edited version of the media item (e.g., edited media item 145) based on the editing instructions. Accordingly, the user may watch the edited media item 145 without consuming undesired content.

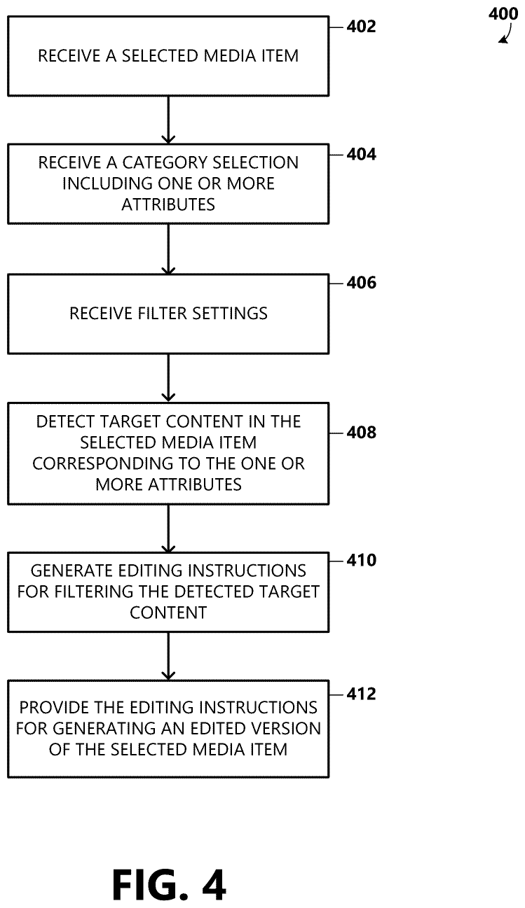

FIG. 4 is a flowchart that includes operations of a method 400 of providing category-based media editing according to another example. For example, one or more of the operations may be performed by components of the editing service 116. With reference now to FIG. 4, at operation 402, a selected media item 125 may be received. For instance, the media item 125 may be selected by a user to be played via a streaming service 106.

At operation 404, a category selection may be received. For instance, the category selection may include information about one or more filter categories selected by the user in association with the selected media item. In some examples, the category selection may further include information about one or more attributes associated with the selected category(s).

At operation 406, various filter settings may be received. For instance, the filter settings may include a predefined or user-selected filtering level of a category, attribute, or attribute class. In further examples, the received filter settings may include predefined or user-selected editing filter settings that may correspond to a degree/level of editing (e.g., obfuscation or skipping) to apply to detected target content.

At operation 408, the editor 120 may detect target content in the selected media item 125. For instance, the editor 120 may be trained to recognize patterns and characteristics of attributes of the selected category(s) and record locations in the media item 125 where the patterns and characteristics are detected.

At operation 410, one or more edit sets 135 may be generated, where the edit set(s) include editing instructions to obfuscate, hide, remove, skip, or replace detected target content with other content based on the filter settings. In some examples, the editor 120 is trained to determine a priority ranking for edit instructions that causes edits for one category or attribute to take precedence over the edits of the other category or another attribute. For instance, if editing filter settings indicate a higher level of editing for a first attribute (e.g., a first edit) and a lower level of editing for a second attribute (e.g., a second edit) and a scene includes both attributes, the edit instructions may include a priority ranking that causes the edits corresponding to the first attribute to be prioritized and, thus, for the scene to be edited according to the first edit. At operation 310, the editing instructions may be received by the streaming service 106.

At operation 412, the editing instructions may be used to edit the selected media item 125 and generate an edited version of the media item 125 (an edited media item 145) that may be played via the player 108 on the client device 104 and presented to the user without undesired content.

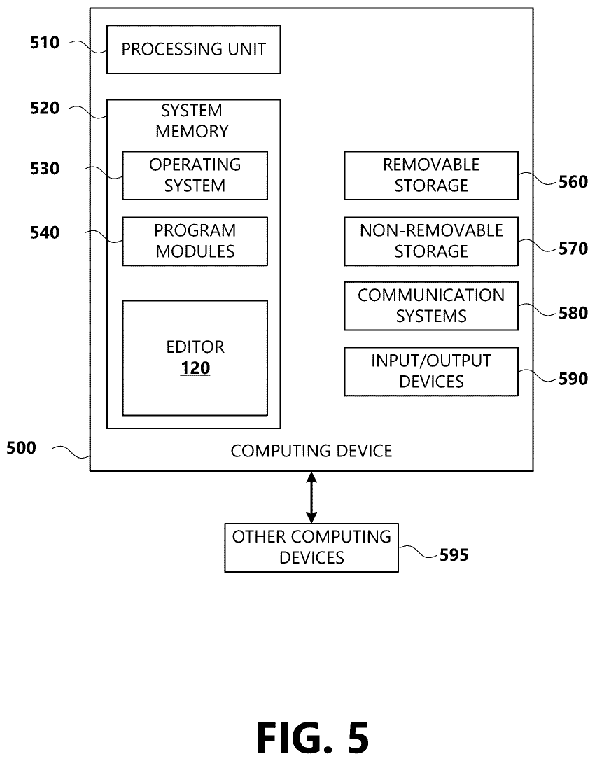

FIG. 5 is a system diagram of a computing device 500 according to an example. The computing device 500, or various components and systems of the computing device 500, may be integrated or associated with the editor 120. As shown in FIG. 5, the physical components (e.g., hardware) of the computing device 500 are illustrated and these physical components may be used to practice the various aspects of the present disclosure.

The computing device 500 may include at least one processing unit 510 and a system memory 520. The system memory 520 may include, but is not limited to, volatile storage (e.g., random access memory), non-volatile storage (e.g., read-only memory), flash memory, or any combination of such memories. The system memory 520 may also include an operating system 530 that controls the operation of the computing device 500 and one or more program modules 540. The program modules 540 may be responsible for performing one more of the operations of the methods described above for providing robust network connectivity. A number of different program modules and data files may be stored in the system memory 520. While executing on the processing unit 510, the program modules 540 may perform the various processes described above. One example program module 540 includes the network site validation and remediation system 350.

The computing device 500 may also have additional features or functionality. For example, the computing device 500 may include additional data storage devices (e.g., removable and/or non-removable storage devices) such as, for example, magnetic disks, optical disks, or tape. These additional storage devices are labeled as a removable storage 560 and a non-removable storage 570.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 500 on the single integrated circuit (chip). The disclosure may also be practiced using other technologies capable of performing logical operations such as, for example, AND, OR, and NOT, including but not limited to mechanical, optical, fluidic, and quantum technologies.

The computing device 500 may include one or more communication systems 580 that enable the computing device 500 to communicate with other computing devices 595 such as, for example, routing engines, gateways, signings systems and the like. Examples of communication systems 580 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 500 may also have one or more input devices and/or one or more output devices shown as input/output devices 590. These input/output devices 590 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 520, the removable storage 560, and the non-removable storage 570 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method, comprising:
receiving a media item;
receiving a category associated with one or more attributes;
detecting target content in the selected media item, wherein the target content includes one or more of the attributes associated with the selected category;
generating editing instructions to filter the target content from the media item; and
providing the editing instructions, wherein executing the editing instructions causes the media item to be edited such that, when played, an edited version of the media item is played with the target content filtered from the media item.

2. The method of claim 1, further comprising receiving an indication of the one or more attributes.

3. The method of claim 2, wherein receiving the indication of the one or more attributes comprises receiving one or more attributes selected or input through a user interface.

4. The method of claim 1, wherein detecting the target content further comprises detecting the one or more attributes based on the received category.

5. The method of claim 1, further comprising receiving filter settings and using the filter settings to detect the target content or generate the editing instructions.

6. The method of claim 5, wherein receiving filter settings comprises receiving a filter level selection in association with one of:
the category; or
the one or more attributes.

7. The method of claim 1, wherein generating editing instructions to filter the target content from the media item comprises generating instructions to perform at least one of:
obfuscating the target content;
skipping the target content;
replacing the target content with other content;
hiding the target content; or
removing the target content.

8. A method, comprising:
receiving selection of a media item from a plurality of editable media items;
providing a plurality of filter categories, where each filter category is associated with one or more attributes;
receiving a selection of a first filter category of the plurality of filter categories;
sending the selected media item and the one or more attributes associated with the first filter category to a machine-learning trained editor to detect target content related to the first filter category in the selected media item;
receiving, from the editor, information about one or more occurrences of detected target content related to the first filter category and editing instructions to filter the one or more occurrences of target content from the media item; and
executing the editing instructions to edit the media item such that, when an edited version of the media item is played, one or more occurrences of detected target content related to the first filter category is filtered from the media item.

9. The method of claim 8, further comprising receiving one or more filter settings and providing the one or more filter settings to the editor to detect the target content or generate the editing instructions.

10. The method of claim 9, wherein receiving filter settings comprises receiving a filter level selection in association with one of:
the category; or
the one or more attributes.

11. The method of claim 8, further comprising
receiving a selection of a second filter category associated with one or more attributes;
sending one or more attributes associated with the second filter category to the machine-learning trained editor to detect target content related to the second filter category in the selected media item;
receiving, from the editor, information about one or more occurrences of detected target content related to the second filter category and editing instructions to filter the one or more occurrences of target content from the media item;
determining a priority of the editing instructions associated with filtering an occurrence of detected target content related to the first filter category and the editing instructions associated with filtering an occurrence of detected target content related to the second filter category, where the occurrence of detected target content related to the first filter category and the occurrence of detected target content related to the second filter category include a same portion of content;
and executing the editing instructions to edit the media item such that, when an edited version of the media item is played, one or more occurrences of detected target content related to the second filter category is filtered from the media item based on the determined priority.

12. The method of claim 11, wherein receiving the selection of the second filter category comprises receiving a new category created by a user.

13. The method of claim 8, wherein executing the editing instructions to edit the media item comprises at least one of:
obfuscating the target content;
skipping the target content;
replacing the target content with other content;
hiding the target content; or
removing the target content.

14. A system, comprising:
at least one processor; and
memory storing instructions that, when executed by the at least one processor, cause the system to:
receive a selection of a media item from a plurality of editable media items;
receive a selection of a first filter category of a plurality of filter categories;
use a machine-learning trained editor to:
detect target content related to one or more attributes associated with the first filter category in the selected media item; and
generate a first set of editing instructions to filter the detected target content from the media item; and
one of:
provide the first set of editing instructions to a player of the media item; or
use the first set of editing instructions to edit the media item; and
provide the edited media item to the player.

15. The system of claim 14, wherein in receiving the selection of the first filter category, the instructions cause the system to receive a new category created by a user.

16. The system of claim 14, wherein in receiving the selection of the first filter category, the instructions further cause the system to receive a selection or input of the one or more attributes associated with the first filter category.

17. The system of claim 14, wherein in generating the first set of editing instructions, the instructions cause the system to generate instructions for at least one of:
obfuscating the target content;
skipping the target content;
replacing the target content with other content;
hiding the target content; and
removing the target content.

18. The system of claim 14, wherein the instructions further cause the system to:
receive a selection of a second filter category associated with one or more attributes;
use the machine-learning trained editor to:
detect target content related to the second filter category in the selected media item; and
generate a second set of editing instructions to filter the target content related to the second filter category from the media item; and
one of:
provide the second set of editing instructions to the player of the media item; or
use the second set of editing instructions to edit the media item; and
provide the edited media item to the player.

19. The system of claim 18, wherein when a portion of the media item includes detected target content related to the first filter category and the second filter category, the instructions further cause the system to:
receive filter settings;
determine a priority between the first set of editing instructions and the second set of editing instructions based on the received filter settings; and
prioritize the first set of editing instructions and the second set of editing instructions based on the determined priority.

20. The system of claim 14, wherein the machine-learning trained editor is trained using a labeled dataset including examples of features of content associated with the one or more attributes and features of content that are not.
